(19) United States
(12) Patent Application Publication
(10) Pub. No.: US 2024/0047970 A1
(43) Pub. Date: Feb. 8, 2024

(54) Systems and Methods for Energy Conversion to and from an Electric Vehicle

(71) Applicant: Atlis Motor Vehicles, Inc., Mesa, AZ (US)

(72) Inventors: Victor Atlasman, Mesa, AZ (US); Rosten Sweeting, Mesa, AZ (US); Levi Clayton, Mesa, AZ (US)

(73) Assignee: Atlis Motor Vehicles, Inc., Mesa, AZ (US)

(21) Appl. No.: 18/231,262

(22) Filed: Aug. 8, 2023

Related U.S. Application Data
(60) Provisional application No. 63/396,010, filed on Aug. 8, 2022.

(51) Int. Cl. H02J 3/32; B60L 55/00; B60L 53/62; H02M 3/335

(52) U.S. Cl. CPC H02J 3/322; B60L 55/00; B60L 53/62; H02M 3/33584; B60Y 2200/91; B60L 2210/30; B60L 2210/40

(57) ABSTRACT

An electric vehicle includes a bi-directional converter. The bi-directional converter converts AC or DC energy to DC energy for charging the battery of the electric vehicle. The converter converts DC energy from the battery to AC or DC energy for driving a load. The converter is attached to and travels with the electric vehicle. The converter may receive and provide three-phase, split-phase and single-phase AC energy.

### BACKGROUND

Embodiments of the present invention relate to electric vehicles.

Present electric vehicles receive energy (e.g., power) to charge the battery of the electric vehicle. Some electric vehicles are adapted to allow the battery to provide energy to a load that is separate from the electric vehicle (e.g., house, camping equipment) as DC energy or as AC energy in a single or a multi-phase arrangement. It would be advantageous for an electric vehicle to receive energy for and provide energy from its battery as AC energy with three phases in addition to single and split phases.

### SUMMARY

Electrical energy may be provided to an electric vehicle to charge the battery of the electric vehicle. The energy may be provided as AC or DC power (e.g., energy). When the electric vehicle receives energy in the form of AC power (e.g., AC voltage), the electric vehicle may include a converter that converts the AC power into DC power (e.g., DC voltage) for charging the battery. The converter includes a detector that determines the type of AC power (e.g., characteristics such as voltage, current, phase, frequency, RMS voltage, RMS current, peak voltage, peak current, phase angle) provided. In accordance with data from the detector, a controller automatically configures the converter to convert the detected AC power to DC power with the characteristics (e.g., voltage, current) needed to charge the battery.

Electrical energy may also be provided from the battery of an electric vehicle to a load. The load is separate from the electric vehicle and is not a system of the electric vehicle. The energy provided to the load may be provided as DC power or AC power. When the electric vehicle provides energy in the form of AC power, the electric vehicle may include a converter to convert the DC power from the battery to AC power for the load. The converter includes a detector that determines the type of AC power required by the load. In accordance with data from the detector, a controller automatically configures the converter to convert the DC power from the battery to the type of AC power needed by the load.

In an example embodiment, the converter that converts energy from AC to DC and from DC to AC is part of the electric vehicle. Because the converter is part of the electric vehicle, the electric vehicle may receive AC or DC energy at any location for charging the battery. Further, the electric vehicle may provide AC or DC energy to a load at any location. The bi-directional converter is coupled to the electric vehicle and travels with the electric vehicle.

The circuitry of the electric vehicle may also enable the electric vehicle to be compatible with a smart grid. The circuitry of the electric vehicle receives information regarding the operation of the smart grid and may provide information to aid the smart grid in its operation. Further, because the electric vehicle may provide power from its battery to an electrical grid (e.g., public, private), the electric vehicle may be considered to be a form of a power plant. As a power plant, the electric vehicle may function as a virtual power plant/supply. As a power plant, the electric vehicle may cooperate with the grid to provide energy to the grid consistent with the needs of the grid.

The circuitry of the electric vehicle may further use information collected by the vehicle and/or from the grid to make decisions regarding when to charge the battery and when and where to provide energy to a device or the grid. The rules governing when and/or where electric vehicle provides energy may be determined through rule discovery using data as the input to artificial intelligence system.

### BRIEF DESCRIPTION OF THE DRAWING

Embodiments of the present invention will be described with reference to the figures of the drawing. The figures present non-limiting example embodiments of the present disclosure. Elements that have the same reference number are either identical or similar in purpose and function, unless otherwise indicated in the written description.

FIG. 1 is a diagram of system for providing energy to or receiving energy from an electric vehicle.

FIG. 2 is a diagram of the voltages of AC energy provided by a delta connection.

FIG. 3 is a diagram of the voltages of AC energy provided by a wye-connection.

FIG. 4 is a diagram of the electric vehicle receiving AC energy from an AC charger (electric vehicle supply equipment) for charging the battery.

FIG. 5 is a diagram of an example embodiment of the AC charger of FIG. 4.

FIG. 6 is a diagram of the electric vehicle providing AC energy from the battery of the electric vehicle to a load.

FIG. 7 is a diagram of an example embodiment of a bi-directional converter that receives AC or DC energy for charging the battery of the electric vehicle and provides AC or DC energy from the battery to the load.

FIG. 8 is a diagram of an example embodiment of a plug on a cable that connects to the electric vehicle to provide and receive AC or DC energy.

FIGS. 9-11 are diagrams of an example embodiment of adapters that adapt from one type of receptacle to another type of receptacle.

FIG. 12 is a diagram of an example embodiment of a receptacle panel that has a receptacle configured to receive adapters.

### DETAILED DESCRIPTION

### Overview

In an example embodiment, an electric vehicle 100 includes a battery 160. The battery 160 receives energy (e.g., power) while being charging. The energy that flows into the electric vehicle 100 is referred to herein referred to as incoming energy. The battery 160 may also provide energy to a load (e.g., sink 610, power sink) that is separate from the electric vehicle. The energy that flows out of the electric vehicle 100 to a load is herein referred to as outgoing energy. The electric vehicle 100 also includes a bi-directional converter (e.g., converter) 130. The bi-directional converter 130 may receive incoming energy as AC (i.e., alternating current) energy. For example, the bi-directional converter 130 may receive AC energy from AC charger 400. AC charger 400 may also be referred to as electric vehicle supply equipment 400. The bi-directional converter 130 may convert the AC energy into DC (i.e., direct current) energy that may be used to charge the battery 160.

The bi-directional converter 130 may also receive DC energy from the battery 160. Energy provided to the battery 160 for charging the battery or received from the battery may be referred to as battery energy. Battery energy has DC characteristics. The bi-directional converter 130 may convert the DC energy from the battery 160 into AC energy or DC energy having DC characteristics different from those characteristics of the battery energy. The bi-directional converter 130 may provide the AC or DC energy to a load to power the load. For example, the bi-directional converter 130 may provide AC energy to power sink 610. The power sink 610 may use the AC energy to perform work. The bi-directional converter 130 may provide outgoing energy in the form of AC energy which includes three phase AC energy, split phase AC energy and single-phase AC energy among other characteristics.

The bi-directional converter 130 is physically coupled to (e.g., connected to, mounted on) the electric vehicle 100 and is mechanically and electrically coupled to the receptacle (e.g., outlet) 110 position on the electric vehicle that is used for receiving energy to charge the battery 160. Because the bi-directional converter 130 is physically coupled to the electric vehicle 100, the bi-directional converter 130, along with receptacle 110, battery 160, controller 140 and receptacle panel 132, travel (e.g., move) with the electric vehicle 100 wherever it goes.

The electric vehicle 100 also includes a controller 140. The controller 140 controls the operation in connectivity of the bi-directional converter 130. An electronic device 150 may be configured to provide a user interface so a user may provide instructions to and receive information from the controller 140. The electronic device 150 may be part of the electric vehicle 100 (e.g., part of a dashboard, part of a vehicle computer) or separate from the electric vehicle 100 (e.g., smart phone, tablet, portable computer). The electronic device 150 may communicate with the controller 140 via a wired communication link (not shown) and/or a wireless communication link 152.

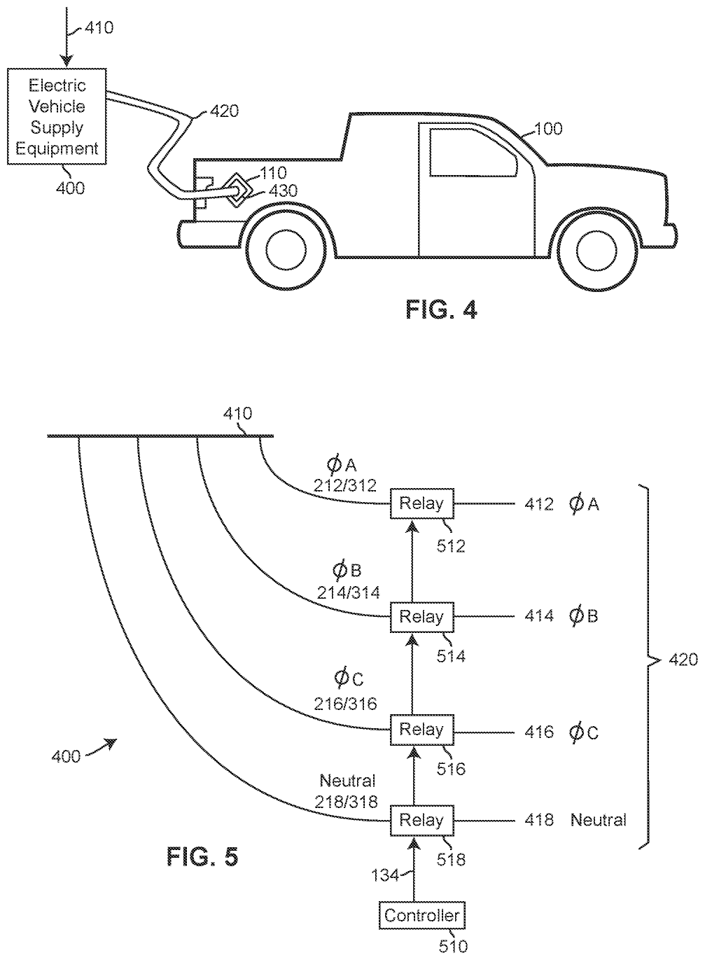

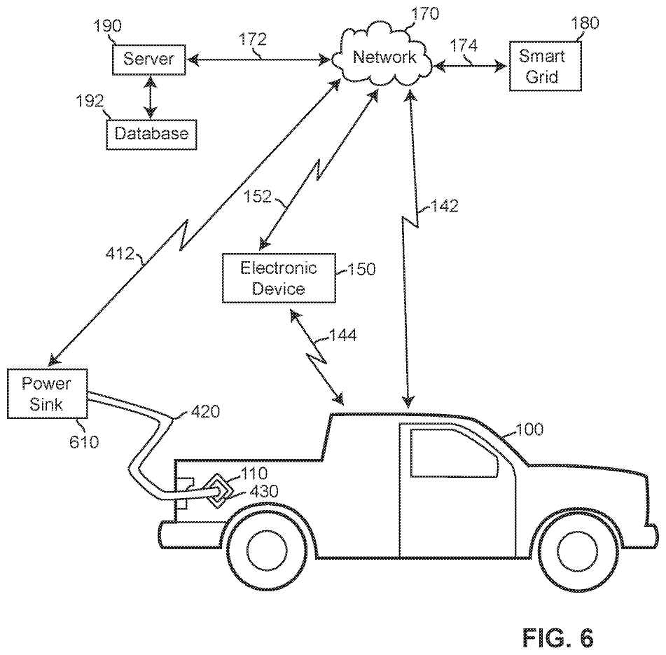

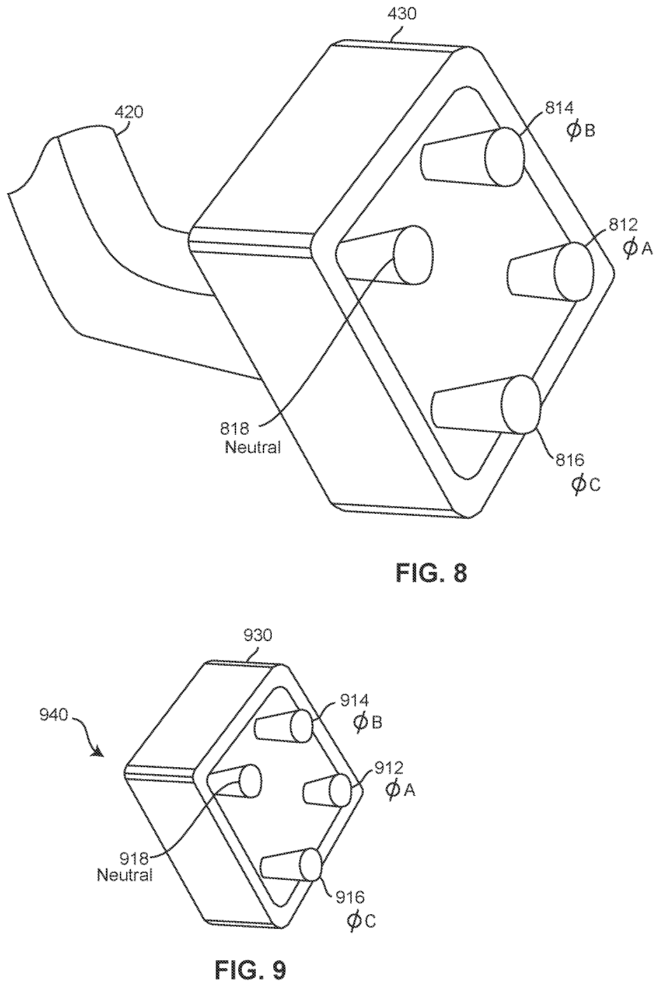

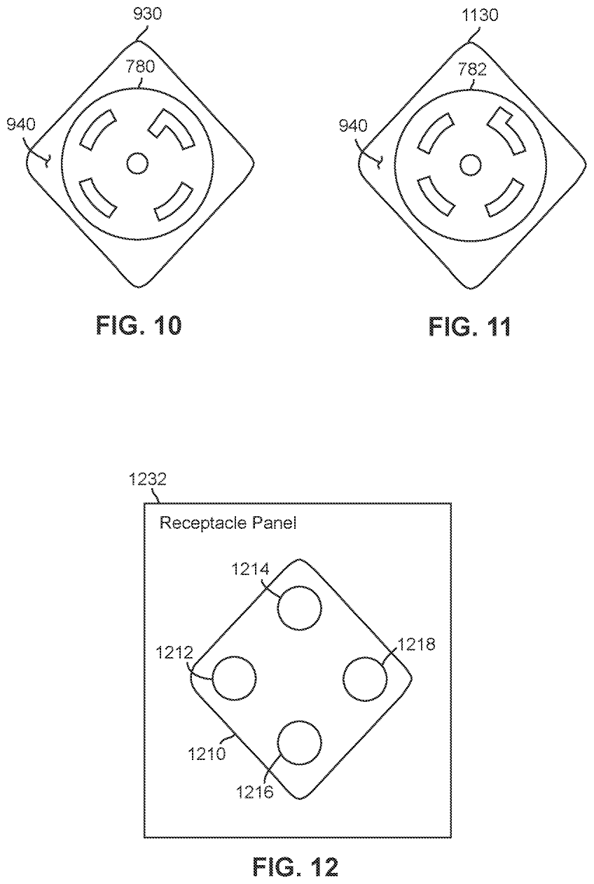

The electric vehicle 100 includes a receptacle 110. The receptacle 110 is configured to connect to a plug 430 which in turn connects to a cable 420. The receptacle 110 is accessible for mechanically and electrically coupling to the plug 430 and thereby to the cable 420. In an example embodiment, the receptacle 110 is externally accessible with respect to the body of the electric vehicle 100. The cable 420 may connect to AC charger 400 or to the power sink 610. The receptacle 110, the plug 430 and the cable 420, shown in FIGS. 4 and 7-8, are configured to provide AC energy in the form of three phase AC energy, split phase AC energy and single-phase AC energy. The receptacle 110, the plug 430 and the cable 420 may also be configured to provide and/or receive DC energy (e.g., 1 conductor for power, 3 conductors for ground; 2 conductors for power, 2 conductors for ground, and so forth). Adapters may be coupled to receptacle 110 so can connect to things other than cable 420 and plug 430.

The controller 140 of the electric vehicle 100 is also configured to wirelessly communicate with a network 170. The network 170 may communicate with a smart grid 180 via communication link 174. The controller 140 may receive data from and provide data to the smart grid 180. The controller 140 may regulate the operation of the electric vehicle in accordance with data received from the smart grid 180. The controller 140 may further communicate with a server 190 via the network 170. The server 190 matter access to the database 192 for providing information to the controller 140 or storing information from the controller 140. The data of the database 192 may be used to develop rules to control the provision energy to and the receipt of energy from the battery 160.

### AC Energy

The AC energy provided to the bi-directional converter 130 or received from the bi-directional converter 130 may be AC energy in any form or in other words have any characteristics. The characteristics of AC energy may include voltage, current, phase, frequency, RMS voltage, RMS current, peak voltage, peak current and phase angle. The AC energy may have any number of phases. The voltage between the phases of the AC energy or between a phase and a neutral may have any value. The frequency of the AC energy may be any frequency. The current provided by any phase may be of any value. In an example embodiment, the AC energy provided to or received from the bi-directional converter 130 includes the 60-hertz AC energy configurations for industrial and/or residential use in the United States. In another example embodiment, characteristics of the AC energy received or provided by the bi-directional converter 130 are suitable for use in other countries such as Europe.

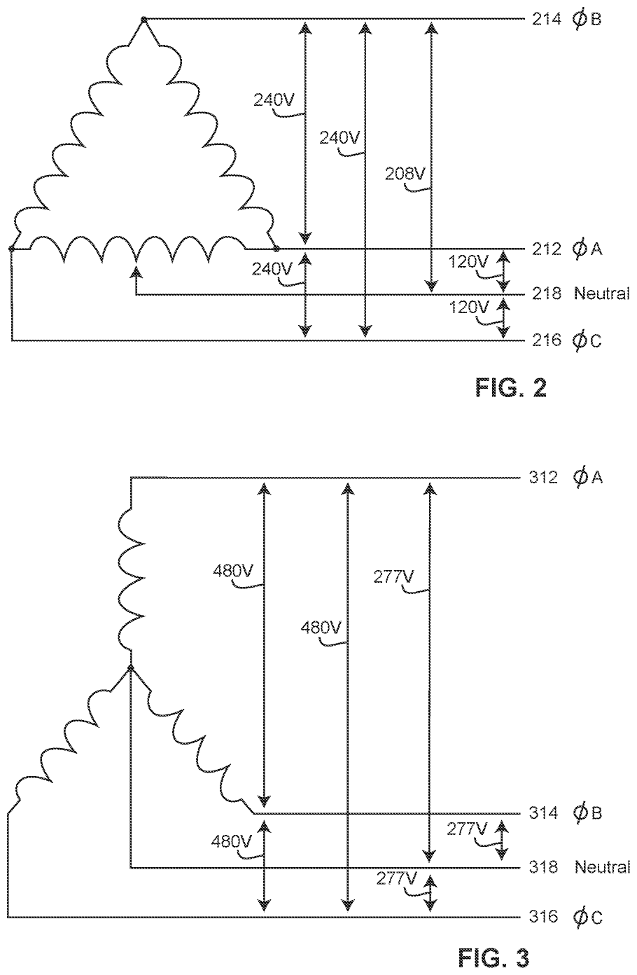

For example, an example embodiment of AC energy is the AC energy provided as three phases and a neutral from a delta connection, as best seen in FIG. 2. In this example embodiment, the energy is provided as three phases: phase-A (e.g., ϕA) 212, phase-B (e.g., ϕB) 214 and phase-C (e.g., ϕC) 216 and the neutral 218. The voltages between the phases and neutral are shown in FIG. 2.

Not all phases need to be used to provide energy. When AC energy is provided as three phase energy from a delta connection, the energy is provided by all four conductors (e.g., ϕA, ϕB, ϕC, neutral) with an alternating current on phase-A, phase-B and phase-C. When AC energy is provided as a split-phase energy, not all four conductors (e.g., ϕA, ϕB, ϕC, neutral) are used to provide the energy. Split-phase energy may be provided by phase-A, phase-B and neutral; or phase-A, phase-C and neutral; or phase-B, phase-C and neutral. The split-phase voltage is 240 V between the phases. The AC energy may also be provided as single-phase energy. Single-phase energy is delivered by two conductors: one phase (e.g., ϕA, ϕB, ϕC) and neutral. The voltages for single-phase, for the delta connection, are 120 V for phase-A or phase-C to neutral and 208 V for phase-B to neutral.

In another example embodiment, the AC energy is provided as three phases and a neutral from a wye-connection (e.g., Y-connection), as best shown in FIG. 3. In this example embodiment, energy is provided as phase-A (e.g., ϕA) 312, phase-B (e.g., ϕB) 314 and phase-C (e.g., ϕC) 316 and a neutral 318. The voltages for three-phase power delivery are identified in FIG. 3. Split-phase AC power is delivered at 480 V AC (e.g., line to line) while single phase AC power is delivered at 277 V AC (e.g., line to neutral).

AC energy may be provided to the electric vehicle 100 in any quantity. In an example embodiment, the AC energy delivered to the electric vehicle 100 is in the range of 1 kW to 50 kW. The AC energy provided by the electric vehicle may be in the range of 1 W to 50 kW.

### A Note Regarding Ground

Earth ground, generally referred to as merely ground, is not shown in the figures of the drawing. Ground is separate from neutral. How ground is handled with respect to neutral depends on the authority having jurisdiction over the area where the equipment (e.g., AC charger 400, power sink 610) is located or the authority having jurisdiction over electric vehicles. For example, in one jurisdiction, neutral 218, neutral 318 and/or neutral 118 may be bonded to or not bonded to earth ground. In another jurisdiction, neutral 218 and neutral 318 are bonded to earth ground but neutral 118 is not. In another jurisdiction, neutral 118 may be bonded to the chassis of the electric vehicle 100. Another jurisdiction may require that all neutrals (e.g., 218, 318, 118, at power sink 610) be bonded to earth ground.

Because the requirements for bonding neutral to earth ground may vary in accordance with jurisdiction, ground is not discussed herein other than to provide notice that the neutral may need to be bonded to an earth ground at some point.

### AC Electric Vehicle Supply Equipment

The AC electric vehicle supply equipment 400 may provide AC energy to the electric vehicle 100 to charge the battery 160. AC electric vehicle supply equipment 400 may also be referred to an AC charger 400 or EVSE 400. AC charger 400 receives electrical energy from utility line-in 410. In most situations, especially at commercial (i.e., non-residential) charging stations, the energy provided by the utility will be three-phase AC energy of the delta or wye-connection variety. Because the electric vehicle 100 includes the bi-directional converter 130, the AC energy provided by utility line-in 410 may be sent directly to the electric vehicle 100.

In an example embodiment of AC charger 400, the conductors for phase-A (e.g., 212, 312), phase-B (e.g., 214, 314), phase-C (e.g., 216, 316) and neutral (e.g., 218, 318) from utility line-in 410 connect to, as best shown in FIG. 5, relays 512, 514, 516 and 518 respectively. Controller 510 controls whether relay 512, 514, 516 or 518 is open or closed. The controller 510 may control the relays 512-518 to provide three-phase, split phase or single-phase AC power to the conductors 412 (e.g., phase-A), 414 (e.g., phase-B), 416 (e.g., phase-C) and/or 418 (e.g., neutral) of cable 420 and thereby to conductors 712, 714, 716 and 718 respectively via the receptacle 110.

The controller 510 may close various combinations of the relays 512-518 to provide three-phase, split-phase or single-phase power to electric vehicle 100. For example, the controller 510 closes all of the relays 512-518 to provide three-phase AC energy to the electric vehicle 100. In another example, the controller 510 closes the relays 512, 514 and 518 to provide one configuration of split-phase AC energy. In another example, the controller 510 closes the relays 512 and 518 to provide one configuration of single-phase AC energy. Energy provided to the electric vehicle 100 is referred to as incoming energy.

In an example embodiment, the controller 510 may receive instructions from a driver as to the AC energy configuration (e.g., three-phase, split-phase, single-phase) to deliver to the electric vehicle 100. The driver may communicate with controller 510 using a keypad on the AC charger 400 (not shown) or via an app running on electronic device 150 (e.g., phone, tablet, mobile computer). In another example embodiment, controller 140 of the electric vehicle 100 provides instructions to the controller 510 as to the AC energy configuration (e.g., characteristics) to provide. The electric vehicle 100 may communicate with the controller 510 via wireless or wired connection. The cable 420 may include two or more conductors, in addition to conductors 412, 414, 416 and 418, for communications between the electric vehicle 100 (e.g., controller 140) and controller 510. In another example embodiment, the AC energy configuration of the AC charger 400 is fixed to a single configuration that does not change, such as three-phase in accordance with a wye-connection.

The AC charger 400 may include any number of transformers, level shifters, filters, or other devices to alter the characteristics of the AC energy provided to electric vehicle 100. In other words, the incoming energy to the electric vehicle 100 may have any set electrical characteristics whether AC or DC.

### The Cable

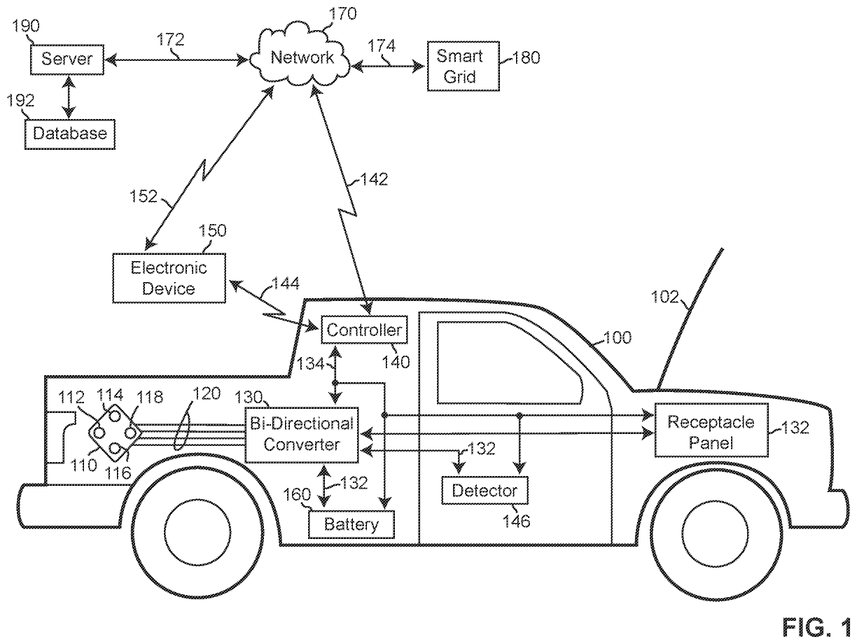

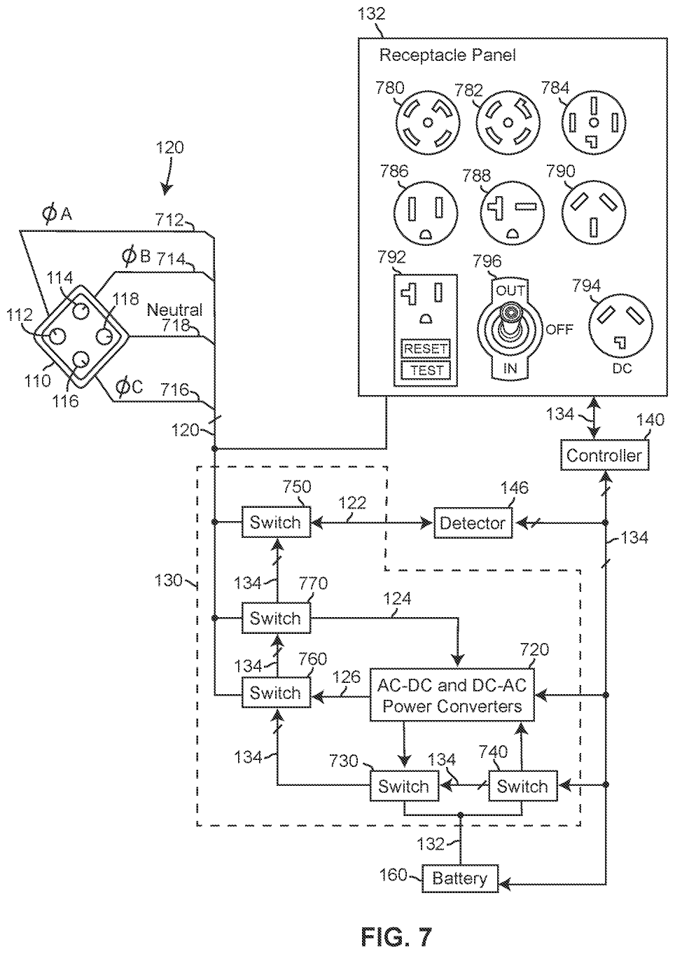

The cable 420 has four conductors, 412, 414, 416 and 418 as best seen in FIG. 5, for delivery of energy. As discussed above, the cable 420 may include two or more additional conductors (not shown) for enabling communication between the electric vehicle 100 and the controller 510. The conductors 412, 414, 416 and 418 electrically connect to pins 812, 814, 816 and 818 respectively of the plug 430. Physically connecting the plug 430 to the receptacle 110 electrically connects the pins 812, 814, 816 and 818 to the receivers 112, 114, 116 and 118 respectively of receptacle 110 and thereby to conductors 712, 714, 716 and 718 respectively, which are identified as conductors 120 in FIGS. 1 and 7.

For AC energy, the conductors 412, 414, 416 and 418 correspond to phase-A, phase-B, phase-C and neutral respectively. For DC energy, at least one conductor of the conductors 412, 414, 416 and 418 carries a DC voltage while at least one conductor is ground.

The conductors of the cable 420, the housing of plug 430, pins 812, 814, 816 and 818, the housing of receptacle 110, receivers 112, 114, 116 and 118 and/or conductors 712, 714, 716 and 718 may be cooled using a gas or liquid medium.

In another example embodiment, an adapter (e.g., 930, 1130) may be plugged into the receptacle 110 and a cord attached to a charger or a load may be plugged into the receptacle (e.g., 780, 782) of the adapter thereby replacing cable 420 and plug 430.

### Detector

A detector 146 detects the type of energy (e.g., AC, DC) being provided to the electric vehicle 100 and/or the type of energy that should be provided by the electric vehicle 100 to a load. In other words, the detector 146 detects whether the energy being provided (e.g., incoming energy) or that needs to be provided (e.g., outgoing energy) is AC or DC and the characteristics (e.g., voltage, current, phase, frequency, RMS voltage, RMS current, peak voltage, peak current, phase angle) of the energy. The detector 146 may also determine the characteristics of a load (e.g., resistance, reactance, impedance, reluctance) while determining the characteristics of the energy that should be provided as outgoing energy to the load (e.g., 610). The characteristics of the energy may be described as a set of characteristics.

In an example embodiment, a detector includes sensors (e.g., voltage, current, time, reactance, capacitance, inductance), pulse generators, voltage generators (e.g., sources), current generators, signal analyzers (e.g., oscilloscope) or any other type of circuit or device needed to analyze the characteristics of energy or a load (e.g., circuit). The detector 146 may analyze the data captured by the sensors and perform calculations to determine a set of characteristics of energy (e.g., power). Further, the detector 146 may analyze the data captured by the sensors with respect to the characteristics of a load to determine the characteristics of the energy that should be provided to the load.

For example, when energy is provided to the electric vehicle 100 (e.g., AC charger 400), the detector 146 detects whether the energy is AC or DC. In the case of AC energy, the detector 146 detects the phases (e.g., A, B, C) on which energy is being provided, the voltage of each phase, the frequency of each phase, the relationship between each phase, and any other characteristic needed by the controller 140 to configure the AC-DC and DC-AC power converters 720 (e.g., power converters 720. In the case of DC energy, the detector 146 detects the voltage on the various conductors (e.g., 712-718) and the relationship of the voltage between the conductors.

The detector 146 reports the detected characteristics (e.g., set of characteristics) to the controller 140. In the case of receiving incoming energy to charge the battery 160, the controller 140 uses the data (e.g., information) regarding characteristics of the incoming energy to configure the power converters 720 to convert the incoming energy to the energy type required to charge the battery 160. The energy provided to the battery 160 may be referred to as the charge energy.

For example, the detector 146 detects the phase of incoming AC energy. As discussed above, an alternating current need not be carried on each of the receivers 112 (e.g., phase-A), 114 (e.g., phase-B) and 116 (e.g., phase-C) if the AC energy is provided as split-phase or single-phase energy. The detector 146 reports the phases of the incoming energy as part of the set of characteristics to the controller 140 to inform the controller 140 which conductors carry an alternating current. The detector 146 may also report other characteristics such as the voltage between the phase conductors (e.g., 112, 114, 116) and between any phase conductor (e.g., 112, 114, 116) and the neutral conductor (e.g., 118) in addition to any other characteristic identified above.

In another example, while electric vehicle 100 is needed to provide energy to a load, the detector 146 detects the characteristics of the load to determine the type of energy to be provided to the load. The detector 146 is configured to impress (e.g., apply) electrical signals (e.g., pulses, ramps, voltages, currents, rms voltages, rms currents) on individual conductors or between any number of conductors of the conductors 120 (e.g., 712-718). The detector 146 is configured to sense (e.g., detect) a response to the impressed electrical signals. The controller 140 may control the detector 146 as to the types of electrical signals to impress on the conductors 120. The detected responses to the impressed electrical signals are reported to the controller 140. Using the information as to the electrical signal impressed and the responses, the controller 140 may determine whether the load (e.g., 610) is connected to the receptacle 110 (or receptacle panel 132, 1232), the type of load, the characteristics of the electrical energy that the c bi-directional onverter 130 should provide to the load and outgoing energy. The detector 146 cooperates with the controller 140 in determining the electrical characteristics of the outgoing energy.

For example, the detector 146 in combination with the controller 140 may determine that a load (e.g., 610) is connected to the receptacle 110. Further, the detector 146 and the controller 140 may determine that load requires energy having specific requirements, such as AC three-phase in accordance with the wye-connection shown in FIG. 3. In another example, the detector 146 and controller 140 determine that the load is connected to receptacle 794 of receptacle panel 132. The detector 146 and the controller further determined that the load requires DC energy with a high-voltage (e.g., positive, negative) on conductors 712 and 716 (e.g., phase-A, phase-C) and ground on the other two conductors 714 and 718 (e.g., phase-B, neutral). The controller 140 uses the detected data regarding the characteristics of the DC energy to configure the power converter 720 to convert DC energy from the battery 160 to the detected energy type needed by the load. The energy provided from the battery 160 to be provided to a load may be referred to as load energy. The load energy and the charge energy have the electrical characteristics of the battery 160. The charge energy, as discussed above refers to the energy flowing into the battery. The load energy refers to the energy flowing out of the battery. The charge energy and the load energy may have the same set of electrical characteristics.

The receptacle 110 may include mechanical or electrical sensors that determine when a plug has been inserted into the receptacle 110. Some or all of the other receptacles (e.g., 780-794) the receptacle panel 132 may have mechanical or electrical sensors that determine when a plug has been inserted into any of the other receptacles. The receptacle panel 1232 may include a mechanical or electrical sensors for detecting when an adapter (e.g., 930, 1130) is inserted into receptacle 1210. The receptacle 1210 includes receivers 1212, 1214, 1216, 1218 for receiving the pins 912, 914, 916 and 918 on an adapter. Sensors that detect whether something is inserted into receptacle 110, the receptacles of receptacle panels 132 or 1232 may provide their data to the detector 146 and/or the controller 140. Insertions in to a receptacle (e.g., 110, 780-794, 1210) maybe detected and reported wirelessly using monitors (e.g., 720, 820) as described in U.S. provisional patent application 63/467,869 filed May 19, 2023 with docket no. 1807.142.020, which is incorporated herein by reference in its entirety and for any purpose.

A user may insert a plug into any of the receptacles of receptacle panel 132 or the receptacle (930, 1130) of an adapter plugged into the receptacle 1210 of the receptacle panel 1232. Just as the detector 146 may detect whether plug 430 has been inserted into receptacle 110, the detector 146 may detect whether a plug has been inserted into any of the other receptacles a receptacle panel 132 or receptacle of an adapter plugged into the receptacle 1210 of the receptacle panel 1232. The detector 146 may further determine the electrical characteristics of the source or the load attached to the plug that is plugged into any of the receptacles of receptacle panel 132 and/or receptacle panel 1232.

The Bi-Directional Converter

As discussed above, the bi-directional converter 130 converts energy having a first set of electrical characteristics into energy having a second set of electrical characteristics. The bi-directional converter 130 may convert energy coming into the electric vehicle 100 and energy going out of the electric vehicle 100, so the conversion of energy is bi-directional as suggested by the name. For example, the bi-directional converter 130 may convert incoming energy (entering the electric vehicle 100) to charge energy (e.g., entering the battery 160) or load energy (e.g., exiting the battery 160) to outgoing energy (exiting the electric vehicle 100).

In converting energy, regardless of direction of flow, the bi-directional converter 130 may convert (e.g., alter, change) any electrical characteristic of the energy. For example, the bi-directional converter 130 may convert energy from AC energy, having any first set of electrical characteristics, to DC energy, having any second set of electrical characteristics, and vice a versa.

In an example embodiment, best seen in FIGS. 1 and 7, the bi-directional converter 130 includes AC-DC and DC power converters 720 (herein referred to as power converters 720), switch 730, switch 740, switch 750, switch 760, and switch 770. In another example embodiment, switch 740 may be omitted and detector 146 accesses the conductors 120 via switch 770. Incoming energy and outgoing energy enters and exits the bi-directional converter 130 via the conductors 120 (e.g., 712, 714, 716 and 718). The switch 770 directs incoming energy from the conductors 120 to the conductors 124 and into the power converters 720. The switch 760 directs outgoing energy from the conductors 126 to the conductors 120. The switches 760 and 770 are never closed (e.g., low impedance, conductive, on) at the same time.

The switch 750 electrically connects the conductors 120 to the conductors 122. The conductors 122 connect to the detector 146. The detector 146 may sense electrical characteristics of the energy on the conductors 122, and thereby the conductors 120. The detector 146 may further apply (e.g., impressed) signals on the conductors 122 and thereby on the conductors 120. Generally. The switches 760 and 770 are closed at the same time because the detector 146 may need to drive the conductors 120. While the detector 146 is only sensing the electrical characteristics of the energy on the conductors 120, the switch 750 may be closed. While the detector 146 is driving signals on to the conductors 120, the switches 760 and 770 should be open (e.g., high impedance, non-conductive, off).

The conductors 122, 124 and 126 have the same number of conductors as the conductors 120 and are arranged in the same manner.

The switch 730 directs charge energy from the power converters 720 to the battery 160. The switch 740 directs load energy from the battery 160 to the power converters 720. The switches 730 and 740 may be consolidated to a single switch.

The power converters 720 may include additional switches for directing incoming energy and load energy to the inputs of specific AC-DC or DC-AC converters. The power converters 720 may include additional switches for directing charge energy and outgoing energy from the output of specific AC-DC or DC-AC converters to the battery 160 and the conductors 120 respectively.

The switches 730-770 may be implemented in any manner using any technology that can switch the flow of electrical energy. In an example embodiment, the switches 730-770 are implemented using relays (e.g., conventional, solid-state). In another example embodiment, the switches 730-770 are implemented using high-voltage semiconductor switches. Fuses (e.g., conventional, efuse) may be used to protect the power converters 720, the switches (e.g., 730-770) and/or the battery 160.

The switches 730-770, and any switches in the power converters 720, are controlled by the controller 140 via a bus 134. The bus 134 includes as many conductors (e.g., lines, signals) as needed to control any number of switches used at any time. The controller 140 determines when each switch should be opened or closed. The controller 140 cooperates with the detector 146 to have the information needed to open or close switches.

To receive electrical energy to charge the battery 160, the controller 140 opens the switch 750, so the detector 146 may detect the electrical characteristics of the energy applied to the conductors 712-718. The detector 146 reports the electrical characteristics of the incoming energy to the controller 140. In accordance with the data from the detector 146, the controller 140 configures the power converters 720 to convert electrical characteristics of the incoming energy to the electrical characteristics needed for the charge energy. The controller 140 has knowledge of the electrical characteristics needed for the charge current. The controller 140 may further configured switches within the power converters 120 to switch (e.g., direct) the incoming energy to the proper converters. The controller 140 closes the switch 772 direct the incoming energy to the power converters 720. The controller 140 closes the switch 730 to direct the converted energy, the charge energy, to the battery 160. The charge energy charges the battery 160. The switch 750 remain closed, so that the detector 146 may monitor the electrical characteristics of the incoming energy or switch 750 may be opened because detector 146 has finished its job. Switches 760 and 740 are open.

The controller 140 is configured to communicate with the battery 160 via the bus 134. As the charge energy charges the battery 160, the controller 140 may monitor the state of charge (e.g., SOC, fullness, level) of the battery 160. Once the battery 160 reaches the desired level of charge, the controller 140 is configured to control the power converters 720 to stop providing the charge energy. This may be accomplished by opening switch 770. The controller 140 may also open the switch 730.

To provide electrical energy to a load (e.g., 610), the controller 140 opens switch 750, so that the detector 146 may determine whether a load is connected to the receptacle 110, the receptacles 780-794 or the receptacle 1210. The detector 146 and controller 140 may further perform tests to determine the characteristics of the outgoing electrical energy that will be provided to the load. In accordance with the results of the tests, the controller 140 configures the power converters 720 to convert the electrical characteristics of the load energy from the battery 160 to the electrical characteristics of the outgoing energy needed by the load. The controller 140 closes switch 740 direct the load energy from the battery 160 to the power converters 720. The controller 140 has knowledge of the electrical characteristics of the load energy provided by the battery 160. The controller 140 configures any switches in the power converters 720 to direct the load energy to the AC-DC or DC-AC converters to provide the outgoing energy with the proper electrical characteristics. The controller 140 may further configure the AC-DC or DC-AC converters to convert the electrical characteristics of the charge energy to the electrical characteristics of the outgoing energy that are needed by the load. The controller 140 closes the switch 760 two direct the converted outgoing energy to the conductors 120. The outgoing energy then flows to the load via one of the receptacles 110, 780-794 or 1210. The controller 140 may leave switch 750 closed so the detector 146 to monitor the characteristics of the outgoing energy. The switches 770 and 730 remain open.

In a first example embodiment, the power converters 720 convert the load energy from the battery 160, which has DC electrical characteristics, to the outgoing energy, which has AC electrical characteristics consistent with the characteristics of the delta connection shown in FIG. 2. In a second example embodiment, the power converters 720 convert the load energy from the battery 160, which has DC electrical characteristics, to the outgoing energy, which has AC electrical characteristics consistent with the characteristics of the wye-connection shown in FIG. 2. In a third example embodiment, the power converters 720 convert the load energy from the battery 160, which has DC electrical characteristics, to the outgoing energy, which has AC electrical characteristics needed for any conventional load in any country of the world. In a fourth example embodiment, the power converters 720 convert the load energy from the battery 160, which has DC electrical characteristics, to the outgoing energy, which also has DC electrical characteristics needed for any conventional load in any country of the world. In a fifth example embodiment, the power converters 720 convert the incoming energy from a source, which has any conventional AC or DC electrical characteristics, to the electrical characteristics of the charge energy needed to charge the battery 160.

In another example embodiment, the detector 146 does not perform tests to detect whether a source or a load is connected to one of the receptacles 110, 780-794 or 1210 because the receptacles include a mechanical, electrical and/or electromechanical detector that detects when a plug is plugged into any one of the other receptacles 110, 780-794 or 1210. The detector reports the receptacle (e.g., 110, 780-794 or 1210) to which the source or the load is connected to the detector 146 and/or the controller 140. The detector 146 may then proceed to detect the electrical characteristics of the incoming energy or to determine the electrical characteristics of the outgoing energy required by the load.

In another example embodiment, the detector 146 does not impress signals on the conductors 120 to determine the type of load connected to the receptacle (e.g., 110, 780-794 or 1210) to determine the electrical characteristics of the outgoing energy to be provided to the load. In this embodiment, the user informs the controller 140 of the electrical characteristics of the energy needed by the load. The controller 140 configures the power converters 720 in accordance with the data from the user so that the outgoing energy has the proper electrical characteristics.

### AC-DC and DC-AC Converters

The power converters 720 include any type of converters needed to change the electrical characteristics of one type of energy to the electrical characteristics of another type of electrical energy. The power converters 720 may convert DC energy have a first electrical characteristics to DC energy having a second electrical characteristics. The power converters 720 may convert DC energy having a first electrical characteristics to AC energy having a second electrical characteristics. The power converters 720 may convert AC energy having a first electrical characteristics to DC energy having a second electrical characteristics. The power converters 720 may convert AC energy having a first electrical characteristics to AC energy having a second electrical characteristics.

The AC-DC and DC-AC converters of the power converters 720 have energy ratings sufficiently high to convert energy within the specifications (e.g., voltage, current, current density) of the battery. The bi-directional converter 130 may include any type of electrical, electronic, and/or electromechanical circuit for protecting the bi-directional converter 130 from situations that may cause damage (e.g., overvoltage, undervoltage, spikes, high density, temperature).

The DC-AC converters of the power converters 720 may convert DC energy into AC energy in any manner, using any technique and/or components. In an example embodiment, the DC-AC converters are implemented using inverters (e.g., sine wave, modified sine wave, square wave, step). The AC energy provided by the DC-AC converters ranges from 110 V AC to 3000 V AC with any number of phases at any frequencies. Preferably, the DC-AC converters provide AC energy that conforms to the requirements of conventional electrical equipment whether residential or industrial (e.g., 60 Hz, 50 Hz, single-phase, delta-connection, wye-connection, so forth).

The AC-DC converters of the power converters 720 may convert AC energy to DC energy in any manner, using any technique and or components. In an example embodiment, the AC-DC converters are implemented using rectifiers (e.g., full wave). The DC energy provided by the AC-DC converters ranges from 50 V DC to 2000 V DC and 50-3000 amps±20%, preferably 200 A±20%. Preferably, the AC-DC converters provide the DC energy at 400 V DC or 800 V DC at 50 A to 200 A±20%.

AC-DC and DC-AC converters may include current limiters, temperature detectors, shutoff circuits, voltage limiters, heatsinks or any other type of circuit or device needed to protect the operation of the AC-DC and DC-AC converters or the load. The electrical characteristics of the AC or DC energy may be altered using any type of level shifters, transformers, filters or smoothing circuits. Any faults detected may be reported to the controller 140 and/or the user via electronic device 150.

### Receptacle Panels and Adapters

The electric vehicle 100 includes receptacle 110. The physical and electrical characteristics of receptacle 110 correspond to the electrical and physical characteristics of the plug 430. The plug 430 is used at all charging stations configured to recharge the electric vehicle 100. It is conceivable that the electric vehicle 100 will never need to be connected to any source or any load accepted through a plug (e.g., 430) that conforms to the physical and electrical characteristics of the receptacle 110. However, since the bi-directional converter 130 enables the electric vehicle to receive or provide energy having any electrical characteristics, it is conceivable that the electric vehicle 100 will be used to provide electrical energy to loads in a variety of situations that do not use plugs that conform to the physical and electrical characteristics of receptacle 110. So, the electric vehicle 100 may include a plurality of receptacles and/or adapters for enabling the user to easily connect the electric vehicle to a variety of loads or sources.

The electric vehicle 100 may optionally include receptacle panel 132, receptacle panel 1232 that uses adapters to provide a variety of conventional receptacles, or adapters (e.g., 130, 1130) for use with receptacle 110. The receptacle panel 132 provides a plurality of receptacles, in this case for conventional US power configurations, for convenient use by the user. Although the receptacle panel 132 shows only receptacles (e.g., 780-794), the receptacle panel 132 may also include plugs, so that the user may attached either end of an extension cord or cable to the receptacle panel 132.

When the user wants to provide outgoing energy to a load, the user may plug the cord from the load into the appropriate receptacle (e.g., 780-794) or into an appropriate adapters connected to the receptacle 1210 of the receptacle panel 132. The detector 146 may detect the identity the receptacle into which the load is plugged and/or the characteristics of the outgoing energy that should be supplied to the load. The controller 140 configures the bi-directional converter 130 to provide the outgoing energy having the electrical characteristics needed by the load. The battery 160 provides the load energy having the first set of characteristics. The power converters 720 convert the load energy into the outgoing energy having the second set of electrical characteristics. The outgoing energy is provided to the conductors 120 which provide the outgoing energy to the receptacle into which the load is plugged. The outgoing energy powers the load.

In an example embodiment, the user plugs an industrial device that requires three-phase AC energy consistent with a wye-connection as shown in FIG. 3 into receptacle 780. The detector 146 detects that receptacle 780 is in use. The detector and/or the controller 140 knows that receptacle 780 is for wye-connection three-phase AC energy, so the controller 140 configures the power converter 720 to convert the load energy from the battery 160 to wye-connection three-phase AC energy, so the outgoing energy provided by receptacle 780 is wye-connection three-phase AC energy.

In another example embodiment, the user plugs and industrial device that requires three-phase AC energy consistent with a delta connection as shown in FIG. 2 into receptacle 782. The detector 146 detects that the receptacle 782 is in use, so the controller sets the power converters 720 to convert the load energy from the battery 160 into the outgoing energy having the electrical characteristics of three-phase delta connection AC energy.

The receptacles 784, 786, 788, 790, 792 and 794 are for providing three-phase AC energy from a delta-connection as shown in FIG. 2, single phase 120 V AC, single phase 240 V AC, single phase 120 V or 240 V AC, single phase 120 V AC GFI or AFCI and DC energy respectively. When a plug is inserted to any of these receptacles, the controller 140 configures the power converters 722 provide the outgoing energy with the corresponding electrical characteristics.

Receptacle panel 132 also includes toggle switch 796. Toggle switch 796 has three positions: OUT, OFF and IN. When the user attaches a cord to a receptacle (e.g., 780-794) or a plug (not shown) of receptacle panel 132, the user may also set the toggle switch 796 to OUT or IN to indicate whether electrical energy is flowing from the receptacle panel 132 a load or into the receptacle panel 132 from a source respectively. The toggle switch 796 is optional, sense the detector 146 may determine such information.

The controller 140 via bus 134 may configure the receptacle panel so that a single receptacle or plug is active for use by user. The controller 140 may further detect the position of the toggle switch 796 via bus 134.

In another example embodiment, the electric vehicle 100 includes the receptacle panel 1232. The receptacle panel 1232 includes receptacle 1210 which is physically and electrically the same as receptacle 110. The receptacle 1210 receives an adapter (e.g., 930, 1130) to convert the receptacle 1210 to a conventional receptacle. An adapter includes four pins 912, 914, 916 and 918, as best seen in FIG. 9. The pins 912, 914, 916 and 918 have the same physical and electrical characteristics as the pins 812, 814, 816 and 818 respectively an plug 430. The pins 912, 914, 916 and 918 are positioned on a first side of the adapter. The second side 940 of the adapter includes a conventional receptacle (e.g., 780-794). For example, the adapters 930 and 1130 includes the receptacles 780 and 782. Adapters may also include plugs. The user determines the type of receptacle or plug needed to drive a load or to receive energy from a source, inserts the adapter into the receptacle 1210 and plugs the load or source into the receptacle on the second side of the adapter. The detector 146 determines the electrical characteristics of the load or the source and the controller 140 configures the bi-directional converter 130 to provide or receive energy with the appropriate electrical characteristics.

In another example embodiment, the electric vehicle 100 excludes the receptacle panel 132 and the receptacle panel 1232. However, the user inserts adapters (e.g., 930, 1130) into the receptacle 110 to adapt the receptacle 110 to conventional receptacles or plugs. The user then plugs the source or the load into the adapter that is attached to the receptacle 110. The detector 146 detects electrical characteristics of the source or the load and the controller 140 configures the bi-directional converter 130 to provide or receive energy with the appropriate electrical characteristics.

The receptacle panel (e.g., 132, 1232) may be positioned at any location in or on the electric vehicle 100. In an example embodiment, the receptacle panel is positioned under the hood 102 of the front trunk. The hood 102 protects receptacle panel from the elements and must be lifted to access the receptacle panel. In another example embodiment, the receptacle panel is positioned on an exterior of the electric vehicle 100 and protected by a weatherproof, removable cover.

### Usage Scenario: Providing Energy to the Electric Vehicle

Assume the battery 160 of the electric vehicle 100 needs to be charged. The driver directs the electric vehicle 100 to a charging station. The driver inserts (e.g., connects) the plug 430 into the receptacle 110. The plug 430 is mechanically and electrically connected to the cable 420. As discussed above, the cable 420 has at least four conductors for energy delivery. The cable 420 electrically and mechanically connects to the AC charger 400.

In this example, the AC charger 400 provides incoming energy with electrical characteristics consistent with three-phase wye-connection AC energy, so the voltage between the pins 812 (phase-A), 814 (phase-B), 816 (phase-C) and 818 (neutral) is 480 V AC (e.g., line to line) and 277 V AC (e.g., line to neutral). The cable 420 carries the three phases and neutral via respective conductors to the phase-A pin 812, the phase-B pin 814, the phase-C pin 816 and the neutral pin 818 respectively of the plug 430. Inserting the plug 430 into the receptacle 110 mechanically and electrically connects the phase-A pin 812, the phase-B pin 814, the phase-C pin 816 and the neutral pin 818 to the phase-A receiver 112, the phase-B receiver 114, the phase-C receiver 116 and the neutral receiver 118 respectively of the receptacle 110. As discussed above, receivers 112, 114, 116 and 118 electrically connect to the conductors the 712, 714, 716 and 718, referred to as conductors 120, which go to switches 750, 760 and 770.

The detector 146 detects the characteristics of the incoming energy. In accordance with the detected data from the detector 146, the controller 140 configures the bi-directional converter 130 to convert the incoming energy having the AC electrical characteristics discussed above to the charge energy having the DC electrical characteristics needed to charge the battery 160. The controller 140 sets the switches 730-770 to direct the incoming energy to the power converters 720 and charge energy to the battery 160.

Once charging is completed as detected by the controller 140 via the bus 134, the controller 140 opens switch 770 to stop the flow of incoming energy and switch 730 to stop the charge energy to the battery 160. The controller 140 informs the user. The user removes the plug 430 from the receptacle 110 thereby electrically and mechanically disconnecting the AC charger 400 from electric vehicle 100. The controller 140 configures the battery 160 to deliver DC energy to the systems of the electric vehicle 100, so the electric vehicle 100 may be driven and operated. The circuits for delivering DC energy from the battery 160 to the systems of the electric vehicle 100 are not shown. While the electric vehicle 100 is being driven, the electric vehicle 100 neither receives incoming energy nor provides outgoing energy via the receptacle 110.

Usage Scenario: Receiving Energy from the Electric Vehicle

Assume that the electric vehicle 100 has been driven to a campsite during a time of year when it is cold. The driver has set up a tent and wants to power an AC electric heater that is inside the tent. In this example, the electric heater performs the function of the power sink 610. In this case, the inserts and adapters into receptacle 110. The second side 940 of the adapter includes the receptacle 786. The user plugs the heater into the receptacle 786. The detector 146 detects that a load has been plugged into the receptacle 110. The detector 146 detects the type (e.g., the electrical characteristics) of energy needed by the heater.

Consistent with the electrical characteristics detected by the detector 146, the controller 140 configures the bi-directional converter 130 to provide outgoing energy to power the heater. In this case, the electrical characteristics of the outgoing energy is single phase 120 V AC. The controller 140 configures the power converters 720 to convert the load energy from the battery 160 to the outgoing energy provided to the heater via the receptacle 110 and adapter. The load energy has a first electrical characteristics, which are DC characteristics, and the outgoing energy has a second electrical characteristics, which are single phase 120 V AC. The bi-directional converter 130 converts and provides the outgoing energy to the heater and the user stays warm while camping.

As discussed above, the bonding of earth ground to the neutral 118 conductor is not discussed because it may depend on jurisdiction; however, in this embodiment it is likely that the neutral 118 conductor will need to be bonded to a ground at the heater and to a ground at the electric vehicle 100.

In another example, the driver drives the electric vehicle 100 to a remote mining claim where the driver is prospecting for gold. At the mining claim, the driver wishes the electric vehicle 100 to provide the energy for a three-phase AC motor that operates a screen for sifting dirt and gravel. In this example embodiment, the electric vehicle 100 is equipped with the receptacle panel 132. The user inserts the plug on the motor into the receptacle 780. The user flips the toggle switch 796 to out indicating that energy will be flowing out of the receptacle panel 132.

The detector 146 and/or the controller 140 detects that a plug is inserted into the receptacle 780 for which the electrical characteristics are known, which means that the detector 146 and/or the controller 140 know the electrical characteristics. Further the controller 140 determines that the toggle switch 796 is set to OUT, so the controller 140 knows that the receptacle panel 132 will be providing outgoing energy.

Consistent with the gathered information, the controller 140 sets the bi-directional converter 130 to receive load energy from the battery 160 and to provide outgoing energy to the electric motor via receptacle 780. The controller 140 configures the power converters 720 to convert the load energy from the battery, which has a first set of electrical characteristics, to the outgoing energy, which has a second set of electrical characteristics, in this case three-phase AC wye-connection power. The controller 140 closes switch 740 so that the load energy may flow from the battery to the power converters 720. The controller 140 closes the switch 760 so that the converted outgoing energy may flow to the load via the receptacle 780. The outgoing energy powers the motor, these are the screens tons of dirt and finds a gold nugget the size of a coconut. The user calls a day turns off the motor and unplugged it from the receptacle panel 132. The controller 140 opens switch 740 and switch 760 to stop the flow of outgoing energy.

### Advanced Capabilities

The electric vehicle 100 may further include, inter alia:
a wireless communication link;
an intelligent power management system;
integrated renewable energy source capabilities;
predictive analytics; and
enhanced security measures.

The intelligent power management system includes an advanced AI-driven power management system. The intelligent power management system autonomously decides the amount of energy to be transferred to or from the battery 160 based on a variety of factors. The factors include the present state of charge of battery 160, estimated future energy needs of the electric vehicle 100, the priority and power requirements of the external load (e.g., 610) and the availability of other energy sources. The AI provides the ability to manage a load/supply based on average usage and utility bill rates. Events where additional usage of power is needed (such as a hot summer day) would have the system set up the energy to maintain cost savings to the user, using more energy from the battery 160 knowing that it is unlikely that the electric vehicle 100 will be used during the time of use or recharged prior to the time of use. A sensor may be incorporated into the meter panel of the user's home to know of such events.

The user's home may include renewable energy sources such as solar or wind that provide energy for recharging the battery 160. The energy provided by the renewable energy sources may be for the sole use of the user and can be directed entirely to recharging the battery 160. Alternately, the electric vehicle 100 may include a renewable energy source, such as solar cells (e.g., on roof, deployable from front trunk).

With the help of machine learning and predictive analytics, the system predicts future energy needs based on past usage patterns, weather forecasts and the expected range of the electric vehicle 100. Predictive analysis would allow for better energy management and greater convenience for the user. For example, on a hot day, if the charge on the battery 160 is low, the system will balance the load between the storage and the utility effectively.

Advanced security measures secure the electric vehicle 100, and in particular the bi-directional converter 130 from unauthorized use. Biometric authentication or encryption techniques may be used to prevent unauthorized use. Advanced security measures make the electric vehicle 100 and bi-directional converter 130 suitable for sensitive applications such as military operations. Biometric capture and authentication may be performed by electronic device 150 and capabilities of the electric vehicle 100 enabled or disabled by the electronic device 150.

### Smart Grid Compatibility

The controller 140 includes a communication circuit that enables the controller 140 to wirelessly communicate with network 170 via a wireless link 142 and with electronic device 150 via wireless link 144. Wireless communication with network 170 enables the controller 140 to communicate with a smart grid 180. Smart grid 180 is an electrical network (e.g., grid, utility, energy supplier, energy producer) that uses sensors to detect local changes in usage (e.g., consumption, production) and communication technology to react to local changes in usage. One method in which the smart grid 180 may react to a local change is to reconfigure the transmission lines of the network to transport electricity from locations of decreasing demand to locations of increasing demand. The smart grid 180 may also increase or decrease production responsive to demand or the introduction or removal of sources (e.g., power plants, wind farms, solar locations, energy from electric vehicle 100).

For example, the electric vehicle 100 may be connected to the user's home grid and the battery 160 used to provide energy to the home grid thereby decreasing demand from the utility grid. The smart grid 180 may detect the decrease in usage and/or the controller 140 may inform the smart grid 180 that it is now providing energy to the home grid. The smart grid 180 may determine the significance of reduced usage from the user's home grid. The smart grid 180 may take action in accordance with the reduction in use from the user. In a situation where a high percentage of users charge their batteries at work, transport the energy to their home and use the energy from their electric vehicle battery to power their house, the smart grid 180 may be able to steer energy from an entire neighborhood to other areas of high demand to avert bringing on new sources of production.

Another benefit of communication with the smart grid 180 is that the controller 140 may receive detailed data regarding, inter alia:
the cost of electricity over time;
locations of increased or decreased cost over time;
grid capacity over time;
locations of blackouts or brownouts over time; and
availability of electricity over time.

The data from the smart grid 180 may be received and stored over a period of time, such as for an entire year. Additional data may be collected and stored over the period of time, such as whether, the occurrence of holidays or events (e.g., festival, Super Bowl) and/or the occurrence and/or extent of natural disasters. The data may then be analyzed using any methods, including AI, to determine the cost and/or availability of electricity, whether consumed or provided, as affected by, inter alia, the weather, holidays or events, or natural disasters.

Further, the electric vehicle 100 may keep detailed records of its energy use, receipt of incoming energy, production of outgoing energy, and the operating conditions of the electric vehicle (e.g., temperature, speed, acceleration, deceleration, weather, traction, wind speed, and so forth). The data recorded by the electric vehicle 100 may be stored over the period of time.

The result of the data analysis identify preferred times and locations for, inter alia:
charging battery 160 at the lowest cost;
using energy from battery 160 to power the home to reduce overall cost or to reduce peak demand;
using energy from battery 160 to accomplish environmental goals;
charging battery 160 in advance of higher use due to predicted weather or potential natural disaster.

The server 190 may collect the data from the smart grid 180, a source of weather information, a source of calendar related events (e.g., holidays, weekends, events), and from the electric vehicle 100 from the network 170 via the communication link 172. The server 190 may store the collected data in the database 192. The server 190 may analyze the data to determine when and/or where to charge the battery 160 to accomplish economic, environmental and/or security goals. The information regarding the times and places for recharging the battery 160 and/or for providing energy from the battery 160 may be communicated to the controller 140 for implementation.

### Afterword

The foregoing description discusses implementations (e.g., embodiments), which may be changed or modified without departing from the scope of the present disclosure as defined in the claims. Examples listed in parentheses may be used in the alternative or in any practical combination. As used in the specification and claims, the words ‘comprising’, ‘comprises’, ‘including’, ‘includes’, ‘having’, and ‘has’ introduce an open-ended statement of component structures and/or functions. In the specification and claims, the words ‘a’ and ‘an’ are used as indefinite articles meaning ‘one or more’. While for the sake of clarity of description, several specific embodiments have been described, the scope of the invention is intended to be measured by the claims as set forth below. In the claims, the term “provided” is used to definitively identify an object that is not a claimed element but an object that performs the function of a workpiece. For example, in the claim “an apparatus for aiming a provided barrel, the apparatus comprising: a housing, the barrel positioned in the housing”, the barrel is not a claimed element of the apparatus, but an object that cooperates with the “housing” of the “apparatus” by being positioned in the “housing”.

The location indicators “herein”, “hereunder”, “above”, “below”, or other word that refer to a location, whether specific or general, in the specification shall be construed to refer to any location in the specification whether the location is before or after the location indicator.

Methods described herein are illustrative examples, and as such are not intended to require or imply that any particular process of any embodiment be performed in the order presented. Words such as “thereafter,” “then,” “next,” etc. are not intended to limit the order of the processes, and these words are instead used to guide the reader through the description of the methods.

What is claimed is:

1. A system for energy transfer to or from an electric vehicle, the system comprising:
a first receptacle for receiving an incoming energy from a source or providing an outgoing energy to a load;
a bi-directional converter, the bi-directional converter configured to convert a first type of energy to a second type of energy;
a detector, the detector electrically coupled to the first receptacle;
a controller, the controller configured to communicate with the detector and the bi-directional converter; and
a battery; wherein:
the first receptacle, the bi-directional converter, the detector, the controller and the battery are mounted on the electric vehicle, whereby as the electric vehicle moves, the first receptacle, the bi-directional converter, the detector, the controller and the battery move with the electric vehicle;
(1) while receiving the incoming energy:
(a) the detector determines that the incoming energy is the first type of energy, the first type of energy includes AC energy of any voltage and/or number of phases or DC energy at any voltage;
(b) responsive to the detector, the controller configures the bi-directional converter to receive the incoming energy, to convert the first type of energy to the second type of energy and to provide the second type of energy to the battery, the second type of energy is DC energy at a voltage suitable for charging the battery; and
(c) the bi-directional converter receives the incoming energy of the first type of energy via the first receptacle, converts the first type of energy to the second type of energy and provides the second type of energy to the battery to charge the battery; and
(2) while providing the outgoing energy:
(a) the detector determines and reports to the controller that the outgoing energy is the second type of energy, the second type of energy is AC energy at a voltage and with a specific number of phases suitable for the load, or DC energy at a voltage suitable for the load, the load is physically separate from the electric vehicle whereby the load does not move with the electric vehicle;
(b) the controller configures the bi-directional converter to receive the first type of energy from the battery, convert the first type of energy to the second type of energy and provide the second type of energy to the first receptacle as the outgoing energy, the first type of energy is DC energy from the battery; and
(c) the bi-directional converter receives the first type of energy from the battery, converts the first type of energy to the second type of energy and provides the second type of energy to the load via the first receptacle.

2. The system of claim 1 further comprising an adapter, wherein:
a first side of the adapter includes a plurality of pins;
a second side of the adapter includes a second receptacle, the second receptacle configure to couple to the load to provide the outgoing energy to the load;
each pin of the plurality of pins couples to one receiver of the first receptacle;
one or more of the pins of the plurality of pins are coupled to a respective receiver of the second receptacle; and
the load includes a plug that inserts into the second receptacle to receive the outgoing energy.

3. The system of claim 1 further comprising a receptacle panel that includes a plurality of receptacles of different types, wherein:
a plug that is electrically connected to the load is inserted into one receptacle of the plurality of receptacles;
the detector determines an identity of the one receptacle into which the plug is inserted; and
the detector determines the second type of energy required by the load.

4. The system of claim 1 further comprising a first switch, a second switch and a third switch, wherein:
the controller controls whether the first switch, the second switch or the third switch are open or closed;
the controller closes the first switch to electrically couple the detector to the first receptacle;
the controller closes the second switch to electrically couple one or more AC-DC or DC-AC converters to the first receptacle to receive the incoming energy; and
the controller closes the third switch to electrically couple the one or more AC-DC or DC-AC converters to the first receptacle to provide the outgoing energy.

5. The system of claim 1 further comprising a first switch and a second switch, wherein:
the controller controls whether the first switch or the second switch is open or closed;
the first switch and the second switch are not closed at a the same time;
the controller closes the first switch to electrically couple one or more AC-DC or DC-AC converters to the battery to provide the second type of energy to the battery; and
the controller closes the second switch to electrically couple the battery to the one or more AC-DC or DC-AC converters to provide the first type of energy from the battery to the one or more AC-DC or DC-AC converters.

6. The system of claim 1 wherein the detector includes a pulse generator configured to provide one or more pulses to the first receptacle to determine that the load is electrically coupled to the first receptacle.

7. The system of claim 1 wherein the detector includes a pulse generator configured to provide one or more pulses to the first receptacle to determine that the second type of energy is suitable for the load.

8. A system for energy transfer to or from an electric vehicle, the system comprising:
a receptacle for receiving an incoming energy from a source or providing an outgoing energy to a load, the incoming energy having a first set of electrical characteristics, the outgoing energy having a second set of electrical characteristics;
a battery, configured to receive a charge energy having a third set of electrical characteristics and to provide a load energy having a fourth set an electrical characteristics;
a detector, the detector configured to detect the first set of electrical characteristics of the incoming energy and the second set of electrical characteristics for the outgoing energy;
a controller; and
a bi-directional converter, the bi-directional converter configured to convert the incoming energy having the first set of electrical characteristics to the charge energy having the third set of electrical characteristics, the bi-directional converter further configured to convert the load energy having a fourth set of electrical characteristics to the outgoing energy having the second set of electrical characteristics; wherein:
the controller configured to communicate with the detector and the bi-directional converter;
the receptacle, the battery, the detector, the controller and the bi-directional converter are mounted on the electric vehicle, whereby as the electric vehicle moves, the receptacle, the battery, the detector, the controller and the bi-directional converter move with the electric vehicle;
the first, second, third and fourth sets of electrical characteristics include AC or DC electrical characteristics;
the first, second, third and fourth sets of electrical characteristics may differ from each other;
(1) while receiving the incoming energy and in accordance with a data from the detector regarding the first set of electrical characteristics, the controller is configured to configure the bi-directional converter to:
(a) to receive the incoming energy from the receptacle;
(b) convert the incoming energy to the charge energy, the incoming energy having the first set of electrical characteristics, the charge energy having the third set of electrical characteristics; and
(c) provide the charge energy to the battery to charge the battery; and
(2) while providing the outgoing energy to the load and in accordance with the data from the detector regarding the second set of electrical characteristics, the controller is configured to configure the bi-directional converter to:
(a) receive the load energy from the battery, the load energy having the fourth set of electrical characteristics;
(b) convert the load energy to the outgoing energy, the outgoing energy having the second set of electrical characteristics; and
(c) provide the load energy to the load via the receptacle.

9. The system of claim 8 wherein:
the first set of electrical characteristics comprises a three-phase AC energy consistent with a delta connection; and
the third set of electrical characteristics comprises a DC voltage having a value between 400 V and 1600 V.

10. The system of claim 8 wherein:
the first set of electrical characteristics comprises a three-phase AC energy consistent with a wye-connection; and
the third set of electrical characteristics comprises a DC voltage having a value between 400 V and 1600 V.

11. The system of claim 8 wherein:
the fourth set of electrical characteristics comprises a DC voltage having a value between 400 V and 1600 V; and
the second set of electrical characteristics comprises a three-phase AC energy consistent with a delta connection.

12. The system of claim 8 wherein:
the fourth set of electrical characteristics comprises a DC voltage having a value between 400 V and 1600 V; and
the second set of electrical characteristics comprises a three-phase AC energy consistent with a wye-connection.

13. The system of claim 8 wherein the bi-directional converter comprises:
an AC-DC converter that converts the incoming energy having the first set of electrical characteristics consistent with AC energy to the charge energy having the third set of electrical characteristics consistent with DC energy that is suitable for charging the battery; and
a DC-AC converter that converts the load energy having the fourth set of electrical characteristics consistent with DC energy provided by the battery to the outgoing energy having the second set of electrical characteristics consistent with AC energy.

14. A system for energy transfer to or from an electric vehicle, the system comprising:
a battery, the battery configured to receive and provide a battery energy;
a bi-directional converter, the bi-directional converter configured to convert an incoming energy received from a source to the battery energy for charging the battery, the bi-directional converter further configured to convert the battery energy from the battery to an outgoing energy for providing to a load, the incoming energy having a first set of electrical characteristics, the outgoing energy having a second set of electrical characteristics and the battery energy having a third set of electrical characteristics; and
a detector, the detector configured to detect the first and second sets of electrical characteristics; wherein:
the battery, the bi-directional converter and the detector are mounted to the electric vehicle, whereby as the electric vehicle moves, the battery, the bi-directional converter and the detector move with the electric vehicle;
the first, second and third sets of electrical characteristics include AC or DC electrical characteristics;
the first, second and third sets of electrical characteristics different from each other;
(1) in accordance with the detector detecting the first set of electrical characteristics, the bi-directional converter:
(a) receives the incoming energy having the first set of electrical characteristics;
(b) converts the incoming energy to the battery energy having the third set of electrical characteristics; and
(c) provides the battery energy to the battery to charge the battery; and
(2) in accordance with the detector detecting the second set of electrical characteristics, the bi-directional converter:
(a) receives the battery energy having the third set of electrical characteristics from the battery;
(b) converts the battery energy to the outgoing energy having the second set of electrical characteristics; and
(c) provides the outgoing energy to the load.
